(19) United States
(12) Patent Application Publication
(10) Pub. No.: US 2023/0211732 A1
(43) Pub. Date: Jul. 6, 2023

(54) REARVIEW ASSEMBLY

(71) Applicant: GENTEX CORPORATION, Zeeland, MI (US)

(72) Inventor: Bradley R. Hamlin, Allendale, MI (US)

(73) Assignee: GENTEX CORPORATION, Zeeland, MI (US)

(21) Appl. No.: 18/148,451

(22) Filed: Dec. 30, 2022

Related U.S. Application Data
(60) Provisional application No. 63/294,919, filed on Dec. 30, 2021.

(51) Int. Cl. B60R 1/08; B60R 1/24; B60R 1/25; B60R 1/26; B60R 11/02

(52) U.S. Cl. CPC B60R 1/08; B60R 1/24; B60R 1/25; B60R 1/26; B60R 11/0229; B60R 2300/8026; B60R 2300/202

(57) ABSTRACT

A rearview assembly is disclosed. The rearview assembly may comprise: a housing and a display. The housing may be operable to me mounted to a vehicle. More specifically, the housing may be mounted to the vehicle interior. The display may be associated with the housing. Additionally, the display may have a first region and a second region. The first region may be substantially aligned with the housing. The second region may extend substantially beyond the housing. In some embodiments, the display may be a substantially transparent OLED display.

### CROSS-REFERENCE TO RELATED APPLICATIONS

This application claims priority under 35 U.S.C. § 119(e) to U.S. Provisional Application No. 63/294,919 filed on Dec. 30, 2021, entitled “Rearview Assembly,” the disclosure of which is hereby incorporated by reference in its entirety.

### FIELD OF INVENTION

The present disclosure relates, in general, to rearview assemblies and, more particularly, to rearview assemblies having a display.

### SUMMARY

In accordance with one aspect of the present disclosure, a rearview assembly is disclosed. The rearview assembly may comprise: a housing and a display. The housing may be operably mounted to a vehicle. More specifically, the housing may be mounted to the vehicle interior. The display may be associated with the housing. Additionally, the display may have a first region and a second region. The first region may be substantially aligned with the housing. The second region may extend substantially beyond the housing. In some embodiments, the second region may extend at least 30 mm beyond the first region in at least two directions. In some embodiments, the second region may substantially circumscribe the first region. In some embodiments, the display may be a substantially transparent OLED display. Further, a driver of the vehicle may be operable to view a scene forward relative the vehicle through the second region of the display.

In some embodiments, the first region may be operable to display a first part of an image corresponding to a scene rearward relative the vehicle. In some such embodiments, the second region may be operable to display a graphic. Further, the second region may be otherwise substantially transparent beyond the graphic. In other such embodiments, the second region is operable to display a second image corresponding to a scene at least one of sideward or rearward relative the vehicle. The second image may correspond to the vehicle's blind spot. In some instances, the second image may be displayed based, at least in part, on the detection of an object in the vehicle's blind spot. In yet other such embodiments, the second region may be operable between a first state and a second state. In the first state, the second region may be substantially transparent. In the second state, the second region may display a second part of the image, the second part being an extension of the first part of the image.

In other embodiments, the display may be operable between a first state and a second state. In the first state, the first region displays a first part of an image corresponding to a scene rearward relative the vehicle and the second region may be substantially transparent. In the second state, the first and second regions may conjointly display the first part of the image.

In some embodiments, the display may be touch screen. In some such embodiments, the touch screen may comprise user interface touch buttons in the second region of the display. These touch buttons may be located substantially along a bottom of the display according to normal operating conditions of the rearview assembly.

These and other aspects, objects, and features of the present disclosure will be understood and appreciated by those skilled in the art upon studying the following specification, claims, and appended drawings. Further, features of each embodiment disclosed herein may be used in conjunction with, or as a replacement for, features in other embodiments.

### BRIEF DESCRIPTION OF FIGURES

In the drawings:

FIG. 1: a view of an embodiment of a rearview assembly;

FIG. 2: a view of an embodiment of a rearview assembly in a first state;

FIG. 3: a view of an embodiment of a rearview assembly in a second state;

FIG. 4: a view of an embodiment of a rearview assembly in a third state;

FIG. 5: a view of an embodiment of a rearview assembly in a fourth state;

FIG. 6: a schematic representation of a system incorporating a rearview assembly;

FIG. 7: a schematic representation of a first image of a first scene; and

FIG. 8: a schematic representation of a second image of a second scene.

### DETAILED DESCRIPTION

For the purposes of description herein, the specific devices and processes illustrated in the attached drawings and described in this disclosure are simply exemplary embodiments of the inventive concepts defined in the appended claims. Hence, specific characteristics relating the embodiments disclosed herein are not limiting, unless the claims expressly state otherwise.

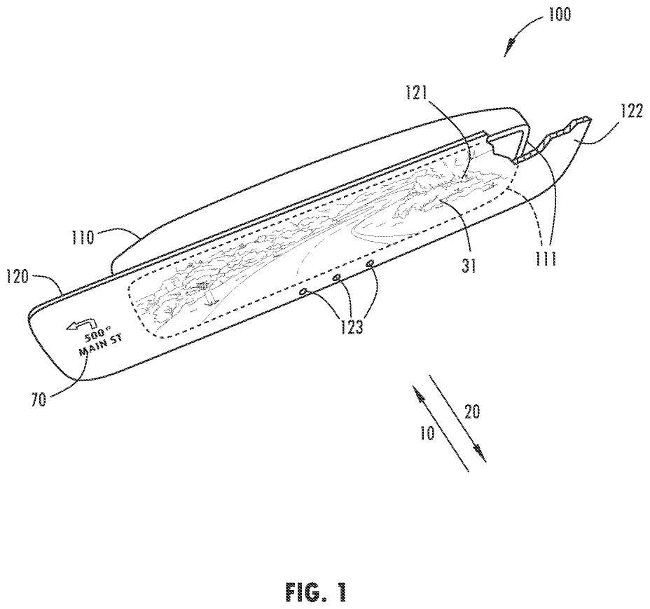

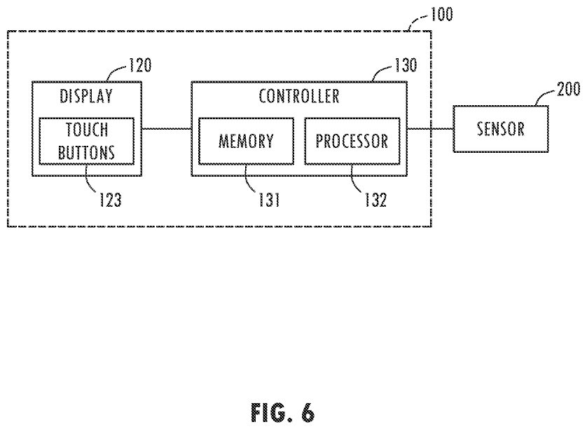

FIGS. 1-6 illustrate aspects of embodiments of a rearview assembly 100. Rearview assembly 100 may comprise a housing 110, a display 120, and/or a controller 130. Further, rearview assembly 100 may be an interior rearview assembly for a vehicle. Accordingly, rearview assembly 100 may be operable to provide a driver with a view rearward relative the vehicle to which it is associated. In some embodiments, rearview assembly 100 may operate in one or more states. For example, rearview assembly 100 may be operable in and/or between a first state 101, a second state 102, a third state 103, and/or a fourth state 104.

Housing 110 may be operable to be mounted to the vehicle. Additionally, housing 100 may be operable to, directly or indirectly, support display 120. In some embodiments, housing 110 may define a cavity for housing one or more electrical components of rearview assembly 100. Further, when viewing rearview assembly 100 in a first direction 10, housing 110 may define a perimeter 111. Viewing rearview assembly 100 in the first direction 10 may substantially correspond to the driver's point of view of rearview assembly 100 under normal operating conditions.

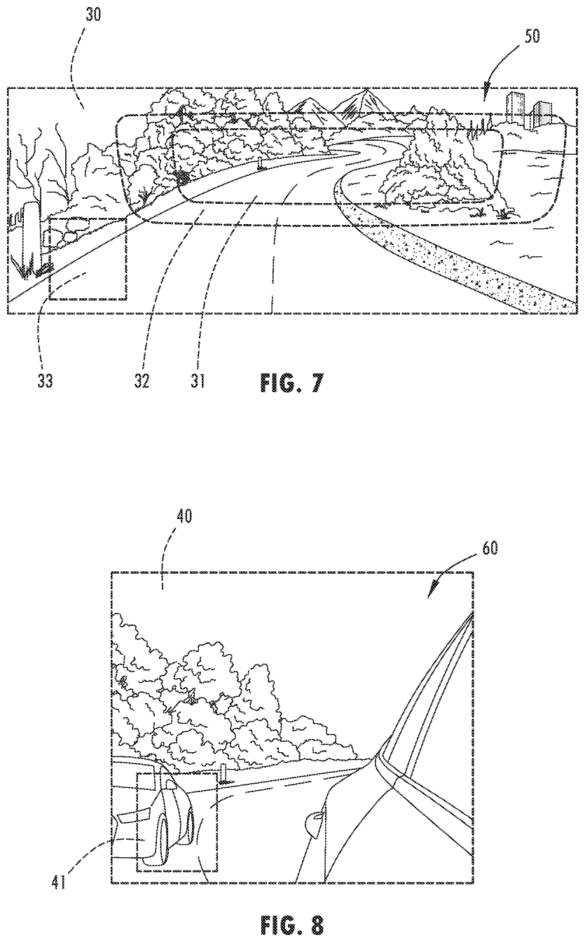

Display 120 may be operable to display, at least part of, a first image 30, as shown in FIG. 7, and/or a second image 40, as shown in FIG. 8, for viewing by the driver. The first and/or second images 30, 40 may be mirrored images. Further, each of the first and/or second images 30, 40 may comprise a plurality of parts. These parts may be different and/or exclusive relative one another. Additionally, at least a part of at least one of the first and second images 30, 40, may correspond to a first scene 50 rearward relative the vehicle, such as one traditionally associated with a view provided by an interior rearview mirror. Similarly, in some embodiments, at least a part of at least one of the first and second images 30, 40, may correspond to a second scene 60 sideward and/or rearward relative the vehicle, such as one traditionally associated with a view provided by an exterior rearview mirror and/or a blind spot, spotter mirror. Further, display 120 may be associated with housing 110. Additionally, display 120 may be disposed in a second direction 20 relative housing 110. Second direction 20 may be a direction opposite first direction 10. Thus, when viewing rearview assembly 100 in a first direction 10, display 120 may be in front of housing 110. Further, the first and second directions 10, 20 may be substantially perpendicular to display 120. In some embodiments, display 120 may be an OLED display. In some such embodiments, the OLED display may be a substantially transparent OLED display.

Additionally, display 120 may comprise a plurality of regions. Further, display 120 may be substantially oversized relative housing 110. For example, display 120 may have a first region 121 and a second region 122. First region 121 may be substantially aligned with housing 110, when viewed in the first direction 10. In some such embodiments, first region 121 may be substantially defined by the alignment with housing 110. For example, first region 121 may be within perimeter 111. Second region 122 may not be in substantial alignment with housing 110, when viewed in the first direction 10. Therefore, second region 122 may extend substantially beyond housing 110. For example, second region 122 may be outside perimeter 111. In some embodiments, second region 122 may be greater than or equal to 10, 15, 20, 25, 30, 40, 50, 60, or 75% of the area of display 120. In some embodiments, second region 122 may form wings on either side of the housing 110. Further, second region 122 may extend at least 30, 40, 50, 60, or 70 mm outward from first region 121. In some embodiments, first region 121 may be immediately adjacent second region 122. As such, first region 121 may seamlessly meet second region 122. In some such embodiments, second region 122 may substantially be an entire remainder of display 120 not within first region 121. In some embodiments, second region 122 may substantially circumscribe first region 121. In some embodiments, where display 120 is a substantially transparent OLED display and second region 122 is not in alignment with, and thus extends beyond, housing 110, the driver may be operable to view a scene forward relative the vehicle through second region 122. Thus, second region 122 may be operable to increase the size of display 120 for rearview assembly 100, without reducing the driver's possible forward field of view.

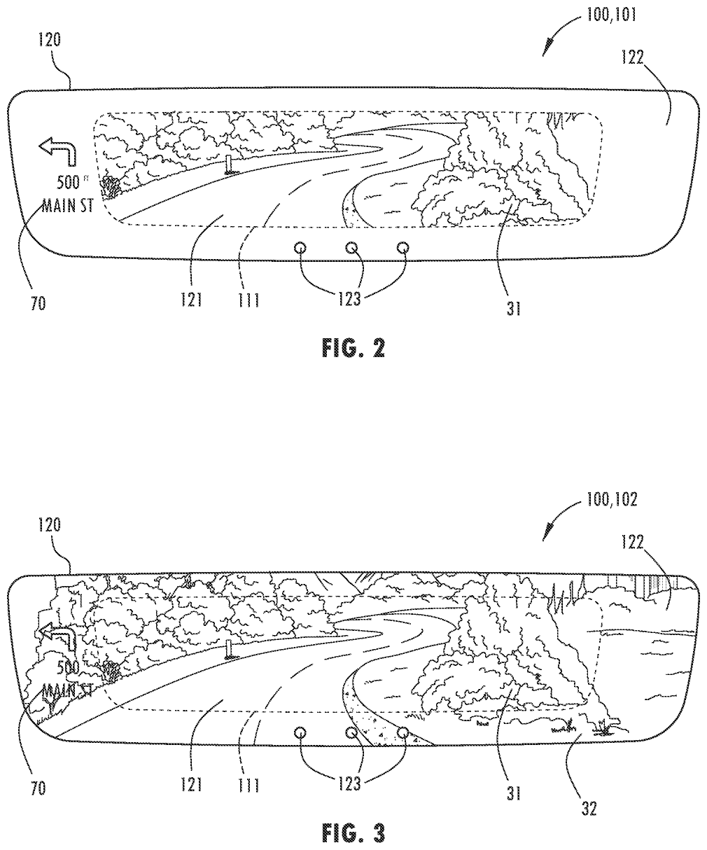

In first state 101, such as shown in FIG. 2, first region 121 may be operable to display a first part 31 of first image 30 and second region 122 may be substantially transparent. In some embodiments, first part 31 may constitute a substantial totality of first image 31. In other embodiments, first part 31 may not constitute a substantial totality of first image 30. Accordingly, the driver's field of view provided by display 120 may correspond only to first part 31. Further, first part 31 may substantially correspond to a traditional field of view for an interior rearview mirror. In some embodiments, in this state, the driver may additionally be operable to view the scene forward relative the vehicle through second region 122.

In second state 102, such as shown in FIG. 3, first region 121 may be operable to display first part 31 of first image 30 and second region 122 may be operable to display a second part 32 of first image 30. Second part 32 is different than first part 31. In some embodiments, second part 32 is exclusive of first part 31 Further, second part 32 may be immediately adjacent to first part 31. In some such embodiments, second part 32 may substantially circumscribe first part 31. Thus, rearview assembly 100 being in second state 102 may cause the first and second regions 121, 122 of display 120 to display the first and second parts 31, 32 of first image 30 as one substantially continuous image. Accordingly, relative first state 101, the displayed image may be perceived by the driver as having an expanded field of view. Therefore, the driver may have a single continuous field of view provided by display 120 that includes both the first and second parts 31, 32.

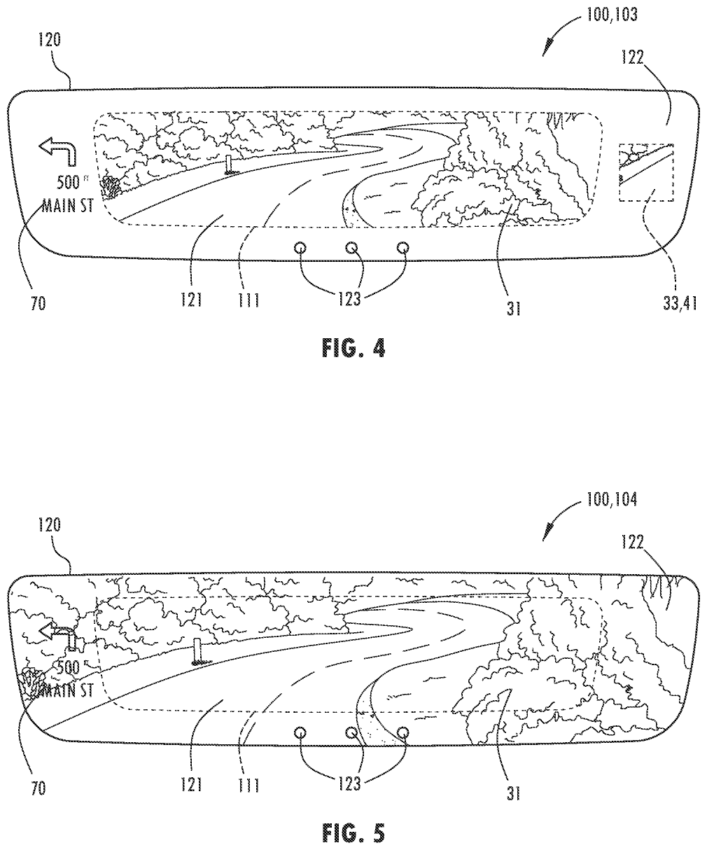

In third state 103, such as shown in FIG. 4, first region 121 may be operable to display first part 31 of first image 30 and second region 122 may be operable to display at least one of a third part 33 of first image 30 and a first part 41 of second image 40. Third part 33 of first image 30 or first part 41 of second image 40 may substantially correspond to a scene sideward and/or rearward relative the vehicle, such as one traditionally associated with a view provided by an exterior rearview mirror and/or a blind spot, spotter mirror. In some embodiments where second region 122 displays third part 33, third part 33 may be substantially not immediately adjacent to first part 31. Accordingly, the driver may have two separate fields of view provided by display 120. In some instances, first image 30 and second image 40 may be captured by two different cameras of the vehicle.

In fourth state 104, such as shown in FIG. 5, first region 121 and second region 122 may be conjointly operable to substantially display first part 31 of first image 30. Accordingly, relative first state 101, the displayed image may substantially have the same field of view, but be perceived by the driver as being substantially enlarged.

In some embodiments, display 120 may be operable to display a graphic overlay 70. Further, display 120 may be operable to display graphic overlay 70 in the first, second, third, and/or fourth states 101, 102, 103, 104. More specifically, second region 122 may be operable to display graphic overlay 70. In states where second region 122 displays part of the first and/or second images 30, 40, graphic overlay 70 may partially occlude part of the displayed first and/or second images 30, 40. In states where second region 122 is in a substantially transparent state, second region 122 may be substantially transparent with the exception of the graphic overlay 70. Additionally, graphic overlay 70 may, for example, be a graphic communicating navigation information, location, traffic information, notifications, and/or entertainment information.

In some embodiments, display 120 may have a touchscreen surface. The touchscreen surface, for example, may comprise a resistive touch, capacitive touch, or infra-red touch technology. Further, display 120 may comprise a user interface of one or more touch buttons 123. These touch buttons 123 may be located in second region 122 of display 120. Thus, from the driver's perspective, the one or more touch buttons 123 may be substantially located to the side or centrally along the bottom of the display according to normal operating conditions of rearview assembly 100. In some embodiments, the one or more touch buttons 123 may be operable to switch rearview assembly 100 between the first, second, third, and/or fourth sates 101, 102, 103, 104.

Controller 130 may comprise a memory 131 and/or a processor 132. Memory 131 may be operable to store one or more algorithms configured to carry out the functions of controller 130 and processor 132 may be operable to execute the one or more algorithms. In some embodiments, controller 130 may be disposed within housing 110. Additionally, controller 130 may be communicatively connected to display 120. As used herein, “communicatively connected” may mean connected directly or indirectly though one or more electrical components. Further, controller 120 may be operable to communicate images, such as the first and/or second images 30, 40, to display 120. These images may be received from one or more imagers associated with the vehicle. Furthermore, in some embodiments, controller 120 may be operable to receive a user input from the one or more touch buttons 123. Based, at least in part, on the input from the one or more touch buttons 123, controller 130 may be operable to change the state that rearview assembly 100 is in. Accordingly, controller 130 may be operable to switch rearview assembly 100 between the first, second, third, and/or fourth states. 101, 102, 103, 104 based, at least in part, on user input. Similarly, in some embodiments, controller 120 may receive or be operable to receive one or more input from one or more sensor 200. Sensor 200 may be a device operable to sense or detect a parameter, such as a location or speed of the vehicle, or the detection of an object, such as another vehicle in a blind spot of vehicle. Accordingly, controller 130 may be operable to switch rearview assembly 100 between the first, second, third, and/or fourth states 101, 102, 103, 104 based, at least in part, on the received input from the one or more sensor 200. Therefore, display 120 may be adaptive between the first, second, third, and/or fourth states 101, 102, 103, 104 in order to suit the driver's changing needs. For example, rearview assembly 100 may: enter third state 103 based, at least in part, on detection of another vehicle in the vehicle's blind spot, in order to provide the driver with an additional view showing the other vehicle's presence; enter the second or fourth states 102, 104 based, at least in part, on the vehicle's location being within a city or a slow speeds where a greater field of view may be beneficial; and enter first state 101 based, at least in part, on the vehicle's location being in a rural location or at high speeds where a greater field of view may be of a lesser benefit and the needs of the forward field of view outweigh the benefit of the increased rearward field of view.

Embodiments of rearview assembly 100 may have one or more advantage over prior rearview assemblies. In some embodiments, rearview assembly 100 may be operable to communicate information to the driver via the graphic overlay 70 with reduced or eliminated occlusion of the driver's field of view provided by rearview assembly 100. Additionally or alternatively, in some embodiments, rearview assembly 100 may have the advantage of an increased display size to either enlarge the displayed image or expand the field of view without permanently increasing the size so as to permanently reduce the driver's overall forward field of view. Further, the increased display size may also have an added benefit to the driver of reduced visual accommodations problems associated with transitioning from looking at an object far off to a near display.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first,” “second,” and the like, are used solely to distinguish one entity or action from another entity or action, without necessarily requiring or implying any actual such relationship or order between such entities or actions.

The term “transparent” is applied in the relative sense. “Transparent” refers to an optical element or material that is substantially transmissive of at wavelengths in question and thus generally allows light at such wavelengths to pass therethrough. The wavelengths in question will vary based on the context. However, in the event the wavelengths in question is not readily apparent, the wavelengths in question shall generally refer to visible light.

For purposes of this disclosure, the term “associated” generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within about 10% of each other, such as within about 5% of each other, or within about 2% of each other.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

What is claimed is:

1. A rearview assembly comprising:
a housing operable to be mounted to a vehicle; and
a display associated with the housing, the display having a first region and a second region, the first region substantially aligned with the housing and the second region extending substantially beyond the housing.

2. The rearview assembly of claim 1, wherein the second region substantially circumscribes the first region.

3. The rearview assembly of claim 1, wherein the display is a substantially transparent OLED display.

4. The rearview assembly of claim 1, wherein a driver of the vehicle may be operable to view a scene forward relative the vehicle through the second region of the display.

5. The rearview assembly of claim 1, wherein the first region is operable to display a first part of an image corresponding to a scene rearward relative the vehicle.

6. The rearview assembly of claim 5, wherein the second region is operable to display a graphic.

7. The rearview assembly of claim 6, wherein the second region is otherwise substantially transparent beyond the graphic.

8. The rearview assembly of claim 5, wherein the second region is operable between a first state and a second state, wherein:
in the first state, the second region is substantially transparent, and
in the second state, the second region displays a second part of the image, the second part being an extension of the first part of the image.

9. The rearview assembly of claim 1, wherein the display is operable between a first state and a second state, wherein:
in the first state, the first region displays a first part of an image corresponding to a scene rearward relative the vehicle and the second region is substantially transparent, and
in the second state, the first and second regions conjointly display the first part of the image.

10. The rearview assembly of claim 1, wherein the display is touch screen.

11. The rearview assembly of claim 10, wherein the touch screen comprises user interface touch buttons in the second region of the display.

12. The rearview assembly of claim 11, wherein the touch buttons are located substantially along a bottom of the display according to normal operating conditions of the rearview assembly.

13. The rearview assembly of claim 1, wherein the second region extends at least 30 mm beyond the first region in at least two directions.

14. The rearview assembly of claim 5, wherein the second region is operable to display a second image corresponding to a scene at least one of sideward or rearward relative the vehicle.

15. The rearview assembly of claim 6, wherein the second image corresponds to a blind spot of the vehicle.

16. The rearview assembly of claim 15, wherein the second region is operable to display the second image based, at least in part, on the detection of an object in the vehicle's blind spot.
